(19) United States
(12) Patent Application Publication
(10) Pub. No.: US 2006/0171143 A1
(43) Pub. Date: Aug. 3, 2006

(54) Handheld rechargeable electric torch

(76) Inventor: Se Kit Yuen, Kowloon (HK)

Correspondence Address: AKERMAN SENTERFITT, P.O. BOX 3188, WEST PALM BEACH, FL, 33402-3188, US

(21) Appl. No.: 11/123,522

(22) Filed: May 6, 2005

(30) Foreign Application Priority Data
Jan. 28, 2005 (CN) 2005200018054

(51) Int. Cl. F21L 4/00

(52) U.S. Cl. 362/157

(57) ABSTRACT

A handheld rechargeable high light electric torch according to the present invention comprises a lamp body having a handheld portion, an illuminator and a switch. The illuminator has a first illuminator and a second illuminator. The first illuminator is arranged at an end of the lamp body and a first light source for long range illumination is arranged in the lamp body. At least a battery, a recharging unit for recharging the battery, a function-convert switching unit and an electronic circuit board are arranged in the lamp body which is a streamlined cylinder. The second illuminator is coupled to the other end of the lamp body and has a second light source serving as a normally lighting lamp during the course of recharging. The first and second light sources are all photoelectron cold cathode illuminators. The electric torch has a plurality of illuminating modes and the recharging unit could not only recharge the battery by means of commercial power but also make the second illuminator operate as a normally lighting lamp. Thus the electric energy is effectively utilized and the illuminating intensity and illuminating distance are improved.

### FIELD OF THE INVENTION

The present invention relates in general to a handheld illuminating lamp. More specifically, the present invention relates to an electric torch which has a light source supplied of power by a battery or commercial power.

### BACKGROUND OF THE INVENTION

Handheld illuminating lamps are widely used in the fields of public security, fire protection and home emergency. Handheld illuminating lamps could have a plurality of holding manners and illuminating modes according to the different purposes, in which a handheld electric torch is the most popular. The conventional electric torch has the disadvantages of deficiency in light source option, low illuminating intensity and short illuminating distance. It is not fit for the operating environment and manner of various illuminating modes. In addition, the conventional electric torch is usually powered by common dry battery and could not be recharged or use commercial power supply. Therefore, service time of such electric torch is short and no dump energy display unit is provided, which is inconvenient for the users.

### SUMMARY OF THE INVENTION

The object of the present invention is to provide an electric torch which provides a plurality of illuminating modes and could be powered by a rechargeable battery or commercial power. The electric torch according to the present invention has a high illuminating intensity and a long illuminating distance.

In order to achieve the above object, a handheld rechargeable high light electric torch according to the first aspect of the present invention comprises a lamp body having a handheld portion, an illuminator and a switch. The illuminator has a first illuminator and a second illuminator. The first illuminator is arranged at an end of the lamp body and a first light source for long range illumination is arranged in the lamp body. At least a battery, a recharging unit for recharging the battery, a function-convert switching unit and an electronic circuit board are arranged in the lamp body which is a streamlined cylinder. The second illuminator is coupled to the other end of the lamp body and has a second light source serving as a normally lighting lamp during the course of recharging. The first and second light sources are all photoelectron cold cathode illuminators.

According to the present invention, the electric torch has a plurality of illuminating modes and could be recharged by the recharging unit for recharging the battery. The recharging unit could not only recharge the battery by means of commercial power but also make the second illuminator operate as a normally lighting lamp. Because the first and second light sources are all photoelectron cold cathode illuminators, the electric energy is effectively utilized and the illuminating intensity and illuminating distance are improved.

In the handheld rechargeable high light electric torch according to the second aspect of the present invention, the first light source has at least a photoelectron cold cathode luminotron, and the first illuminator comprises a first reflecting mirror for reflecting the light from the first light source, a condensing lens and a front cap ring located at the forward end of the condensing lens. The pins of the photoelectron cold cathode luminotron are coupled to the electronic circuit board and fixed in the center of a round hole site of the reflecting mirror.

In the handheld rechargeable high light electric torch according to the third aspect of the present invention, the second light source has at least a photoelectron cold cathode luminotron, and the second illuminator comprises a light collecting pole which is fit over the photoelectron cold cathode luminotron of the second light source, a second reflecting mirror for reflecting the light from the first light source and a lamp shade outside the second light source.

In addition, the lamp body is provided with an energy indicating lamp for displaying the dump energy of the electric torch.

Further, in the handheld rechargeable high light electric torch according to the present invention, the second reflecting mirror has a cambered surface on which a plurality of light reflecting surfaces having different reflection angles are formed.

Further, the front cap ring is made of a flexible material and the lamp body is perpendicular to a plane formed by the end of the front cap ring.

Further, the recharging unit has a movable power plug which is connected to the commercial power. The power plug could move between a first position which is parallel to the lamp body and a second position which is perpendicular to the lamp body.

The present invention provides a product in favor of environmental protection and energy conservation, and it is fit for using in family or in office.

### BRIEF DESCRIPTION OF THE DRAWINGS

FIG. 1 is a side view of a handheld rechargeable high light electric torch according to an embodiment of the present invention;

FIG. 2 is a cross section view of the handheld rechargeable high light electric torch shown in FIG. 1;

FIG. 3 is a bottom view of the handheld rechargeable high light electric torch shown in FIG. 1;

FIG. 4 is a top view of the handheld rechargeable high light electric torch shown in FIG. 1;

FIG. 5 is a front view of the handheld rechargeable high light electric torch shown in FIG. 1;

FIG. 6 is a back view of the handheld rechargeable high light electric torch shown in FIG. 1;

FIG. 7 is a view showing the other side of the handheld rechargeable high light electric torch shown in FIG. 1.

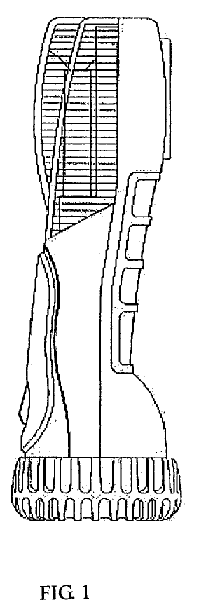

### DETAILED DESCRIPTION OF THE PREFERRD EMBODIMENT

An embodiment of the present invention will be described with reference to the drawings.

The handheld rechargeable high light electric torch according to the present invention comprises a first illuminator having a light source for long range illumination, a lamp body having a rechargeable battery, a function-convert switching unit and an electronic circuit board, and a second light source serving as a normally lighting lamp during the course of recharging.

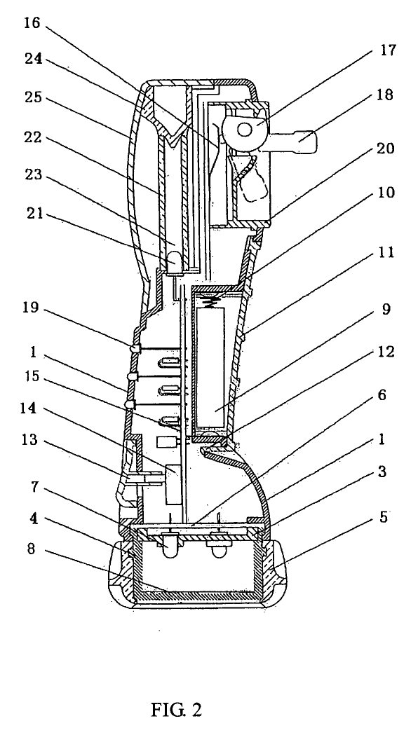

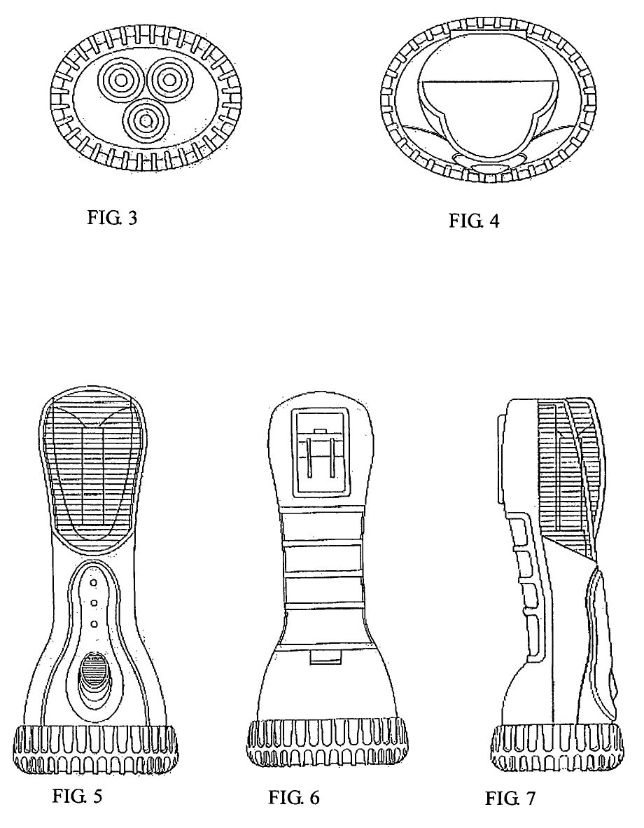

As shown in FIG. 2, the first illuminator is provided with at least a photoelectron cold cathode luminotron 2, a first reflecting mirror 3 having a paraboloid shape (the first reflecting mirror), a condensing lens 4 made of glass or other transparent materials, a front cap ring 5 which is made of flexible materials and arranged at the forward end of the condensing lens 4, with the lamp body being perpendicular to a plane formed of the end of the front cap ring. The pins of the photoelectron cold cathode luminotron 2 are coupled to the circuit board 6 and fixed in the center of a round hole site 7 of the reflecting mirror 3. Light emitted from the photoelectron cold cathode luminotron 2 goes through the condensing convex lens 8 of the condensing lens 4 to be condensed, thus a long range illumination could be achieved by the electric torch.

The second illuminator is coupled to the other end of the lamp body and comprises: a photoelectron cold cathode luminotron 21 which is fixed at an end of a electronic circuit board 15 and is electrically connected; a set of fluorescence semitransparent light collecting pole 22 which is provided on the photoelectron cold cathode luminotron 21, a central hole 23 which penetrates through the pole body being provided axially in the light collecting pole 22 to fit over the photoelectron cold cathode luminotron 21, the light collecting pole 22 being formed of various colors to make the emitted light have different colors; and a reflecting mirror 24 (the second reflecting mirror) which is precisely fit to the upper end of the fluorescence semitransparent light collecting pole 22 and has a cambered surface on which a plurality of light reflecting surface having different reflection angles are formed (now shown in the drawings), the upper end of the reflecting mirror 24 being fixed at the top in the lamp shade 25.

The lamp body is connected between the first illuminator and the second illuminator and comprises a casing 1 on which a handheld portion is provided, at least one battery 9 and metal contact pieces 10 at the two ends of the battery 9. A battery lid 11 which has a latch 12 at one end is provided on the casing 1 above the battery 9. The battery lid 11 could be opened when the user release the latch 12, and then the battery 9 could be took out for replacement. The battery could be a rechargeable one, and a recharging unit and an electronic circuit board are provided in the lamp body. The recharging unit could recharge the battery 9 through an external power supply (such as commercial power) and the electronic circuit board, or directly induce the photoelectron cold cathode luminotron 2, 21 to emit light. The casing 1 is provided at its upper surface with a movable switch lid 13 on the lower end of which a function-convert switching 14 is leaned against. The function-convert switching 14 is fixed on the electronic circuit board 15 and serves to convert the light emitting of different illuminator. One end of the electronic circuit board 15 is provided with two metal members 16 which are in contact with the two metal pins 18 of the movable power plug 17 of the commercial power respectively. Three energy indicating lamps 19 are provided on the upper surface of the casing 1, by which the dump energy of the electric torch is distinctly shown to the user. The movable power plug 17 of the commercial power could move between a first position in which the power plug 17 is parallel to the casing 1 and is accommodated in a power box 20 and a second position in which the power plug 17 is perpendicular to the casing 1 and one pin 18 of the power plug 17 is inserted into a commercial power plug and the other end is in contact with the two metal members 16 of the electronic circuit board 15. It is obvious that the commercial power is supplied to the electronic circuit board 15 via the pin 18 of the power plug 17 and the metal members 16, thus the electronic circuit board is activated to perform the recharging and light emitting functions.

In addition, a plurality of photoelectron cold cathode luminotrons could be used as require, and a plurality of illuminators may be provided on the lamp body. When a plurality of illuminators are combined, each of them has the same structure as described above, and the related description is omitted.

Although a preferred embodiment of the present invention is shown and described, it does not intend to limit the present utility model. It will be appreciated by those skilled in the art that changes may be made in the embodiment without departing from the principles and spirit of the present utility model, the scope of which is defined in the appended claims and their equivalents. For example, the shape and color of the lamp body and the lamp shade could be changed, and the amount, shape, position and material of the members could also be modified.

What is claimed is:

1. A handheld rechargeable high light electric torch comprising a lamp body having a handheld portion, an illuminator and a switch, characterized in that the illuminator comprises a first illuminator which is arranged at an end of the lamp body, and a first light source for long range illumination being arranged in the lamp body, at least a battery, a recharging unit for recharging the battery, a function-convert switching unit and an electronic circuit board being arranged in the lamp body which is a streamlined cylinder; and a second illuminator which is coupled to the other end of the lamp body and has a second light source serving as a normally lighting lamp during the course of recharging, wherein the first and second light sources are all photoelectron cold cathode illuminators.

2. A handheld rechargeable high light electric torch according to claim 1, characterized in that the first light source has at least a photoelectron cold cathode luminotron, and the first illuminator comprises a first reflecting mirror for reflecting the light from the first light source, a condensing lens and a front cap ring located at the forward end of the condensing lens, the pins of the photoelectron cold cathode luminotron being coupled to the electronic circuit board and fixed in the center of a round hole site of the reflecting mirror.

3. A handheld rechargeable high light electric torch according to claim 1 or 2, characterized in that the second light source has at least a photoelectron cold cathode luminotron, and the second illuminator comprises a light collecting pole which is fit over the photoelectron cold cathode luminotron of the second light source, a second reflecting mirror for reflecting the light from the first light source and a lamp shade outside the second light source.

4. A handheld rechargeable high light electric torch according to claim 1 or 2, characterized in that the lamp body is provided with an energy indicating lamp for displaying the dump energy of the electric torch.

5. A handheld rechargeable high light electric torch according to claim 3, characterized in that the second reflecting mirror has a cambered surface on which a plurality of light reflecting surfaces having different reflection angles are formed.

6. A handheld rechargeable high light electric torch according to claim 1, characterized in that the front cap ring is made of a flexible material and the lamp body is perpendicular to a plane formed by the end of the front cap ring.

7. A handheld rechargeable high light electric torch according to claim 1, characterized in that the recharging unit has a movable power plug which is connected to the commercial power and the power plug could move between a first position which is parallel to the lamp body and a second position which is perpendicular to the lamp body.
